(19) United States
(12) Patent Application Publication
(10) Pub. No.: US 2005/0227712 A1
(43) Pub. Date: Oct. 13, 2005

(54) Handset meeting assistant

(75) Inventors: Leonardo William Estevez, Rowlett, TX (US); Carl M. Panasik, Garland, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 10/823,295

(22) Filed: Apr. 13, 2004

(51) Int. Cl. G09G 5/00

(52) U.S. Cl. 455/456.3; 455/556.1; 455/456.1

(57) ABSTRACT

A method comprising accessing an electronic application on a handheld device to determine a time and a location of an upcoming event. The method also comprises determining factors affecting travel time and using said factors to determine an amount of travel time for a user to timely arrive at the upcoming event. The method further comprises providing an alert to the user based on said amount of travel time.

### BACKGROUND

The invention disclosed herein relates to wireless devices. More specifically, the invention relates to providing in an intelligent manner personal information stored on a wireless device.

Handheld computers are sometimes implemented as electronic organizers that comprise a variety of planning tools that help an end-user in scheduling daily activities and appointments. The handheld computers also may provide the end-user with wireless communication capabilities, such as Internet access and cellular network access. Examples of such handheld computers comprise, without limitation, personal digital assistants (“PDA”), mobile phones, portable personal computers and Apple® computers (“laptop”), and other portable, processor-based devices. Many of these handheld computers comprise software applications that provide a variety of features and time management tools, such as appointment books, day planners, address books, memo pads and phone books. An end user may store relevant information in such applications, comprising personal information, times for business appointments and friendly gatherings, telephone numbers and addresses.

Handheld computers equipped with such applications are widely used by a variety of consumers, such as by salespersons, businesspersons and other such individuals. The information storage capability of these applications and other resources available on handheld computers help make the handheld computers virtually indispensable tools in the day-to-day affairs of many consumers.

End-users typically access information entered directly into the handheld computer by a manufacturer, a programmer, the end-user or some other appropriate entity. The end-user also may manually retrieve information from the Internet or other data source. Regardless of the information being accessed or the source of such information, handheld computers and the applications contained therein are generally incapable of generating and providing this information in an intelligent manner. For example, an end-user stores in an electronic calendar a reminder for a business appointment that begins at 11:00 A.M. Thirty minutes prior to the meeting, the electronic calendar may alert the end-user that a meeting is scheduled for 11:00 A.M. In some cases, thirty minutes of travel time may be sufficient for the end-user to arrive at the business meeting in a timely fashion. However, the electronic calendar does not account for other dynamic factors that may affect travel time, such as inclement weather and poor traffic conditions. Furthermore, the electronic calendar does not account for user-specific factors, such as lack of familiarity with the travel route, physical handicaps and so forth. Thus, the handheld computer has failed to provide information in an intelligent manner. In these cases, the end-user may be late for the business meeting, possibly resulting in the loss of time and money. A handheld computer application with the capability to prevent such occurrences is desirable.

### BRIEF SUMMARY

The problems noted above are solved in large part by a method for synergistically combining a handheld computer's applications and resources to provide information in an intelligent, user-friendly manner. One exemplary embodiment may comprise accessing an electronic application on a handheld device to determine a time and a location of an upcoming event. The method also comprises determining factors affecting travel time and using said factors to determine an amount of travel time for a user to timely arrive at the upcoming event. The method further comprises providing an alert to the user based on said amount of travel time.

### BRIEF DESCRIPTION OF THE DRAWINGS

For a detailed description of exemplary embodiments of the invention, reference will now be made to the accompanying drawings in which:

FIG. 1 shows a block diagram in accordance with embodiments of the invention; and

FIG. 2 shows a flow diagram in accordance with embodiments of the invention.

### NOTATION AND NOMENCLATURE

Certain terms are used throughout the following description and claims to refer to particular system components. As one skilled in the art will appreciate, various companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” Also, the term “or” should be interpreted in an inclusive sense instead of an exclusive sense. Thus, if a first device selects a second device or a third device, the first device may select the second device, the third device, or both the second and third devices. Furthermore, the term “couple” or “couples” is intended to mean either an indirect or direct electrical connection. Thus, if a first device couples to a second device, that connection may be through a direct electrical connection, or through an indirect electrical connection via other devices and connections.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

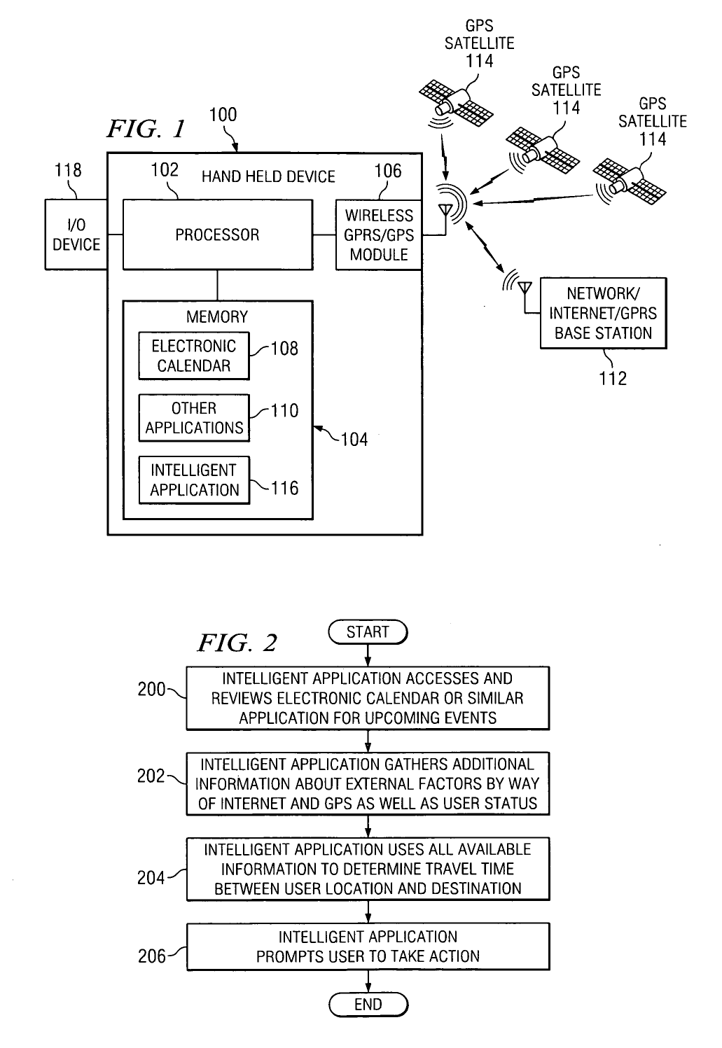

Handheld devices may be adapted to provide information in an intelligent manner with an application that synergistically combines several of the handheld device's applications, capabilities and resources. FIG. 1 illustrates a handheld device 100 comprising a processor 102 coupled to a wireless General Packet Radio Service (“GPRS”)/Global Positioning System (“GPS”) module 106, a I/O device(s) 118 and a memory 104. The memory 104 may comprise processor-executable applications, such as an electronic calendar 108, an intelligent application 116 and other applications 110. The handheld device 100 may be in wireless communications with a network/Internet/GPRS base station 112 and a plurality of GPS satellites 114. The electronic calendar 108 may comprise any time-management tool, such as Microsoft® Outlook®. The I/O device(s) 118 may be any input device, such as a keypad 118, or any output device, such as a display 118. The FIG. 2 shows a flow diagram describing a method by which the intelligent application 116 may provide information in an intelligent manner to an end-user of the handheld device 100.

The method may begin with the extraction of information from the electronic calendar 108 and the other applications 110 by the intelligent application 116 (block 200). Extracted information preferably comprises any information regarding scheduled, future activities of the user. Extracted information may comprise, for example, meeting times, meeting locations, flight times, or any other scheduled activity or engagement. The extracted information also may comprise current time, date, contact information such as e-mail addresses, telephone numbers, fax numbers, or any other such information. The intelligent application 116 uses the extracted information to determine the impending activities in which the end-user is scheduled to participate. The information may be extracted in any of a variety of ways, comprising harvesting cached representations of the electronic calendar 108 stored in a memory as well as extracting electronic calendar information from a separate server by way of the wireless GPRS/GPS module 106.

Among other things, at least one function of the intelligent application 116 is to determine future activities or appointments of the end-user as reflected in the electronic calendar 108 or the other applications 110, to determine the end user's current location, to gather additional information to intelligently determine travel time therebetween, and to present the travel time to the end-user in a helpful, use-friendly format. To gather this additional information, the intelligent application 116 may access information from the internet or receive timing data from the GPS satellites 114 by way of the wireless GPRS/GPS module 106 (block 202). The additional information comprises the end-user's current status (i.e., time, location) as well as information available from other data sources, such as current and projected weather conditions, current and projected traffic conditions, the end-user's current walking or driving speed, and any other information that may be useful or relevant to determining a suitable amount of time for the end-user to reach the location of the next scheduled engagement or activity. The intelligent application 116 uses some or all of the gathered information to determine an appropriate amount of travel time for the next scheduled activity (block 204). In at least some embodiments, the intelligent application 116 determines available travel time by first determining the distance between the end-user's current location and the end-user's intended destination. The intelligent application 116 then may calculate an estimated travel time between the current location and the destination, given normal driving conditions, normal weather conditions, and so forth. The estimated travel time subsequently may be adjusted to account for any of a variety of factors that may affect travel time, such as weather, traffic, road closures or construction, holiday parades, any necessary automobile fueling stops, or any number of other factors, thereby producing a final travel time. In other embodiments, the intelligent application 116 may calculate a final travel time between the current location and the destination by accounting for distance, weather, traffic, road closures, and other such factors all in a single step. Regardless of the embodiment, based on the final travel time, the intelligent application 116 may prompt the end-user to take action so that the end-user may arrive at the next scheduled activity or engagement in a safe and timely manner (block 206).

In an example, an intelligent application 116 may determine through an electronic calendar 108 that an end-user is scheduled to complete a business meeting at 10:00 A.M. in Chicago, Ill. The intelligent application 116 also determines that the end-user has a 12:00 PM flight scheduled to depart from Chicago O'Hare airport to attend a second meeting scheduled for 5:00 P.M. in Houston, Tex. The intelligent application 116 may use the wireless GPRS/GPS module 106 to determine the end-user's location in Chicago. The intelligent application 116 also may assess the location of Chicago O'Hare airport. The intelligent application 116 may assess the location of the airport by using an address stored in the electronic calendar 108 or the other applications 110. Alternatively, the intelligent application 116 may locate the airport by using the wireless GPRS/GPS module 106 to find an address on the internet, or by recalling GPS coordinates stored in the memory 104 from a previous visit to Chicago O'Hare airport by the end-user. With this information, the intelligent application 116 may further determine the distance between the end-user's current location and the airport. In this example, the intelligent application 116 may determine this distance to be 10 miles. Upon determining the distance between the end-user's current location and the airport, the intelligent application 116 may calculate an estimated travel time between the current location and the airport.

Continuing with this example, the intelligent application 116 then may access the Internet or some other data source to determine driving and weather conditions on an optimal route between the airport and the end-user's location. If there exists a traffic closure on the optimal route due to an automobile accident or heavy rains, the intelligent application 116 may determine a detour route. Once an appropriate route has been determined, the intelligent application 116 adjusts the estimated travel time to account for the traffic closure on the optimal route. The intelligent application 116 also may access any other available information that may affect travel time and adjust the travel time accordingly. The intelligent application 116 then prompts the end-user by way of the display 118 to take action so that the end-user may arrive at the airport to be seated in the 12:00 PM flight in a safe and timely manner. Such prompts may be created and stored in the intelligent application 116 by a manufacturer, the end-user or any appropriate entity. A prompt may comprise any type of text message to the end-user, such as “Depart for Chicago O'Hare airport immediately” or “Depart for airport within 5 minutes.” The prompts also may be in the form of an audible ring tone, a vibration, a visually discernible light or any other appropriate stimulus. The prompt may comprise a programmable reminder feature inherent to the electronic calendar 108 and the intelligent application 116 may alter the timing of the reminder to account for the factors described herein. For example, the user may have set a reminder for the return flight to Houston for one hour prior to the flight. The intelligent application 116, however, may automatically change the reminder to remind the user of the flight two hours prior to the flight, due to one or more conditions (e.g., traffic).

The intelligent application 116 also may be adapted to gather information to incorporate into travel time calculations. For example, an end-user may be able to program the intelligent application 116 to account for various other personal factors when determining travel times (e.g., the end-user's personal walking speed, the end-user's driving habits, the end-user's familiarity with a particular city or a particular area within a city). The end-user also may be able to program the intelligent application 116 to monitor the end-user's automobile fuel tank (e.g, using automobile specifications and GPS tracking to determine the number of miles traveled and fuel consumed), so that while calculating travel times, the intelligent application 116 may allow adequate time to visit a fueling station. In some embodiments, the intelligent application 116 may use the wireless GPRS/GPS module 106 to access flight schedules to determine whether a scheduled flight is on-time, ahead of time, late, or cancelled and adjust the travel time accordingly.

In some embodiments, the intelligent application 116 is able to use the wireless GPRS/GPS module 106 to locate destinations or locations listed in the end-user's electronic calendar 108 or other applications 110. However, in other embodiments, the intelligent application 116 may be unsuccessful in locating one or more of the end-user's destinations. For example, a salesman may regularly visit a client's office building, which contains over 300 offices. Further, each time the salesman visits the client, the salesman typically has meeting appointments with at least ten persons, each person having a separate office. Each appointment and associated office number is listed in the end-user's electronic calendar 108. However, the intelligent application 116 would be unable to locate each of the offices by way of the wireless GPRS/GPS module 106, since office building indoor maps are generally unavailable on the Internet or by way of GPS. In such cases, the end-user may manually program the handheld device 100 with the locations of certain offices in a building, or certain buildings on a client's campus. Alternatively, the end-user may program the handheld device 100 with office locations by first commanding the intelligent application 116 to activate the wireless GPRS/GPS module 106 and then physically visiting each office location. For instance, the end-user walks to office 202 and the intelligent application 116 uses the wireless GPRS/GPS module 106 to record the end-user's physical location. The intelligent application 116 then stores this location in the memory 104 under “office 202.” During a future visit, if the end-user's electronic calendar 108 indicates that an appointment is scheduled in office 202, the intelligent application 116 automatically retrieves the physical location information of office 202 from the memory 104. Using this information, the intelligent application 116 makes the necessary travel time calculations and adjustments as described above, with no intervention from the end-user.

In at least some embodiments, the intelligent application 116 may be adapted to automatically send messages to and receive messages from individuals or groups listed in the end-user's electronic calendar 108 or other applications 110. In an example, the intelligent application 116 determines that an end-user's next appointment is at 5:00 PM and that the current time is 4:30 PM. The intelligent application 116 determines that the end-user must immediately begin traveling to the next appointment location in order to arrive at the next appointment location by 5:00 PM, and displays a message on the display 118 advising the end-user to depart for his next appointment. However, the end-user chooses instead to remain at the current location for an additional five minutes and then departs for the next appointment. Thus, the end-user is now five minutes behind schedule and will most likely arrive at the next appointment at 5:05 PM. In such a case, the intelligent application 116 would automatically send an e-mail to individuals attending the meeting, informing the individuals that the end-user will arrive at least five minutes late. The intelligent application 116 may send the e-mail using any available e-mail application in the memory 104, such as Microsoft® Outlook®. The intelligent application 116 also may provide additional messages to the end-user, such as “You may reach the meeting on time if you run” or “Would you like to send a message to the person presiding over the meeting?” The end-user then may respond to such messages from the intelligent application 116 and the intelligent application 116 may act accordingly. In other embodiments, the intelligent application 116 may send messages as described above only upon authorization by the end-user.

In many instances, the end-user may not be in a static position. The end-user may be traveling in an automobile, walking, riding on a subway or dynamically changing location in some other fashion. Thus, there exists a need for the intelligent application 116 to continually update the end-user's location by way of the wireless GPRS/GPS module 106. Referring again to the preceding example, the intelligent application 116 may inform the end-user that the end-user must depart for the 5:00 PM appointment by 4:30 PM. However, the intelligent application 116 must be able to determine when the end-user has begun moving toward the 5:00 PM appointment location. If the end-user begins moving toward the 5:00 appointment location and the intelligent application 116 is not updated to reflect the end-user's change in position, then each subsequent calculation made by the intelligent application 116 may be inaccurate.

To prevent such occurrences, the intelligent application 116 may repeatedly determine the end-user's location at regular intervals programmed by the end-user or some other entity. The end-user may program the intelligent application 116 to determine the end-user's location based on timed intervals (e.g., every 1 second, every 30 seconds, every minute). The intelligent application 116 also may be programmed to determine the end-user's location upon the occurrence of certain events (e.g., a certain time of day, a certain end-user location). In some embodiments, the intelligent application 116 may determine the end-user's location at a frequency that is based on previous movement behavior. In an example, the intelligent application 116 is programmed to check the end-user's location every 30 seconds. Over a period of several location checks, the intelligent application 116 determines that there exists a significant change in the relative location of the end-user. Based upon the amount of change in relative location, the intelligent application 116 may determine whether the end-user is walking, driving a vehicle or otherwise moving at a substantially rapid pace. Upon determining the end-user's method of transportation, the intelligent application 116 may automatically stop determining the end-user's location every 30 seconds and instead may begin determining the end-user's location every 5 seconds or some other appropriate time interval. In this way, the intelligent application 116 possesses accurate information as to the end-user's location. Thus, calculations performed by the intelligent application 116 are more likely to be accurate and precise.

The scope of this disclosure is not limited to the exemplary embodiments described above. The above discussion is meant to be illustrative of the principles and various embodiments of the present invention. Numerous variations and modifications will become apparent to those skilled in the art once the above disclosure is fully appreciated. For example, while the above embodiments are described in terms of GPS, other mechanisms for extracting locality may be used instead, such as 802.11 access points and triangulation techniques such as time of arrival (“TOA”), time difference of arrival (“TDOA”), angle of arrival (“AOA”), or any other appropriate mechanism. Also, while the intelligent application 116 of the above embodiments extracts end-user schedules, phone numbers and other data from an electronic calendar 108 located on the handheld device 100, the intelligent application 116 also may extract such information from a remotely located server or any other source by way of the wireless GPRS/GPS module 106. It is intended that the following claims be interpreted to embrace all such variations and modifications.

1. A method, comprising:
accessing an electronic application on a handheld device to determine a time and a location of an upcoming event;
determining factors affecting travel time;
using said factors, determining an amount of travel time for a user to timely arrive at the upcoming event; and
providing an alert to the user based on said amount of travel time.

2. The method of claim 1, further comprising accessing a network to determine said factors.

3. The method of claim 1, further comprising accessing GPS to determine a current location for the handheld device.

4. The method of claim 1, further comprising determining an estimate of travel time necessary to travel from a handheld device's current location to the location of the upcoming event, wherein determining an amount of travel time comprises adjusting the estimate of travel time based on said factors.

5. The method of claim 1, wherein using said factors comprises using at least one factor selected from the group consisting of traffic conditions, weather conditions, construction work, road work, deviations from scheduled airline flight times, low automobile fuel levels, and lack of user familiarity with a travel route.

6. The method of claim 1, wherein providing an alert comprises providing a visual alert.

7. The method of claim 1, wherein providing an alert comprises providing an audible alert.

8. The method of claim 1, further comprising storing a current location of the handheld device in a memory.

9. The method of claim 1, further comprising electronically communicating with at least one individual at the location of the upcoming event without user intervention.

10. The method of claim 9, wherein electronically communicating comprises sending electronic mail, a voice message or a text message.

11. The method of claim 1, further comprising electronically communicating with at least one individual at the location of the upcoming event upon user authorization.

12. The method of claim 1, further comprising determining a location for the handheld device at programmable intervals.

13. A mobile communication device, comprising:
a processor;
a display coupled to the processor;
a wireless module coupled to the processor; and
a memory coupled to the processor, said memory comprising an electronic application and processor-executable code, said processor-executable code causes the processor to:
access the electronic application to determine a time and a location of an upcoming event;
obtain a current user location using the wireless module;
obtain factors affecting travel time; and
using said factors, determine an amount of travel time for a user to timely arrive at the upcoming event;
wherein either the electronic application or the processor-executable code causes the processor to provide an alert on the display based on said amount of travel time.

14. The device of claim 13, wherein the processor-executable code further causes the processor to determine an estimate of travel time from a current user location to the location of the upcoming event and to adjust the estimate based on said factors.

15. The device of claim 13, wherein the processor-executable code causes the processor to access a network to obtain said factors.

16. The device of claim 13, wherein said factors comprise at least one factor selected from a group consisting of weather data, traffic data, construction work and changes in scheduled airline flight times.

17. The device of claim 13, wherein the processor-executable code causes the processor to store the current user location in the memory.

18. The device of claim 13, wherein the processor-executable code causes the processor to send a signal to at least one individual pertaining to the upcoming event without user intervention.

19. The device of claim 13, wherein the processor-executable code causes the processor to send a signal to at least one individual pertaining to the upcoming event upon user authorization.

20. The device of claim 13, wherein the processor determines the current user location at programmable intervals.

21. The device of claim 13, wherein the wireless module comprises a GPS receiver.

22. The device of claim 13, wherein the wireless module comprises triangulation capability.

23. A system, comprising:
a means for determining a current physical location of a portable device;
a means for storing an adjustable user schedule; and
a means for accessing the user schedule, for determining a travel time from the current physical location to a location of a scheduled event in the user schedule, and for adjusting said travel time based on travel factors to produce an adjusted travel time.

24. The system of claim 23, further comprising means for displaying the adjusted travel time to the user.

25. The system of claim 23, wherein the means for determining a physical location of a portable device comprises a wireless access point.

26. The system of claim 23, wherein the means for network access comprises a General Packet Radio Service.

27. The system of claim 23, wherein the means for storing comprises a server.

28. The system of claim 23, further comprising means for determining the current location of the portable device at programmable intervals.
